(19) United States
(12) Patent Application Publication
(10) Pub. No.: US 2008/0151566 A1
(43) Pub. Date: Jun. 26, 2008

(54) Apparatus for providing an ambient glow

(75) Inventors: Foo Hou Tang, Singapore (SG); Chong Peng Yeo, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/644,599

(22) Filed: Dec. 21, 2006

(51) Int. Cl. B60Q 1/04

(52) U.S. Cl. 362/507

(57) ABSTRACT

There is provided an apparatus made from a translucent solid material for providing an ambient glow. The apparatus includes a substantially cylindrical structure; at least one entry point for light incorporated in the substantially cylindrical structure; and a ridged inner surface of the substantially cylindrical structure. Advantageously, the light entering at the at least one entry point is reflected by the ridged inner surface of the substantially cylindrical structure along the inner surface such that the apparatus provides the ambient glow. The ambient glow may be in a colour of a source of light. Advantageously, the glow may be in at least one colour.

### FIELD OF INVENTION

This invention relates to an apparatus for providing indirect illumination, specifically but not exclusively to an apparatus for providing an ambient glow.

### BACKGROUND

There are illumination devices that provide both direct and indirect lighting. Such illumination devices may be simple like hand held torches, or complex like lighting arrays that illuminate an enlarged area. Generally, the number of light sources employed in illumination devices are directly proportional to a required brightness. A common method of optimizing light transmission intensity from a light source involves the use of reflective surfaces like mirrors. However, light redirection is not employed within the illumination devices.

Usually, many light sources (more than two) are used within the illumination devices rather than light redirection. This use of many light sources is practiced in “angel-eye” headlamps used in automobiles to obtain a uniform ring of illumination. It is generally believed that the higher a number of components being used, the higher the probability of problems occurring.

### SUMMARY

There is provided an apparatus made from a translucent solid material for providing an ambient glow. The apparatus includes a substantially cylindrical structure; at least one entry point for light incorporated in the substantially cylindrical structure; and a ridged inner surface of the substantially cylindrical structure. Advantageously, the light entering at the at least one entry point is reflected by the ridged inner surface of the substantially cylindrical structure along the inner surface such that the apparatus provides the ambient glow. The ambient glow may be in a colour of a source of light. Advantageously, the glow may be in at least one colour.

Preferably, the inner surface of the substantially cylindrical structure may be reflective and/or ridged uniformly. The substantially cylindrical structure may have a cross-sectional profile such as, for example, circle, elliptical or polygonal.

The source for the light may be either LEDs or bulbs. The apparatus may also include attachment clips for mounting the apparatus onto objects. It is advantageous that the distribution of light is uniform in the apparatus. Advantageously, light may enters the at least one entry point from any direction. The at least one entry point for light may include a holder for either at least one LED or at least one bulb.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a perspective view of a preferred embodiment of the present invention from a first angle.

FIG. 2 shows a perspective view of the preferred embodiment of the present invention from a second angle.

FIG. 3 shows a perspective view of a product which uses the preferred embodiment of the present invention.

FIG. 4 shows another application of the preferred embodiment of the present invention.

### DESCRIPTION OF PREFERRED EMBODIMENTS

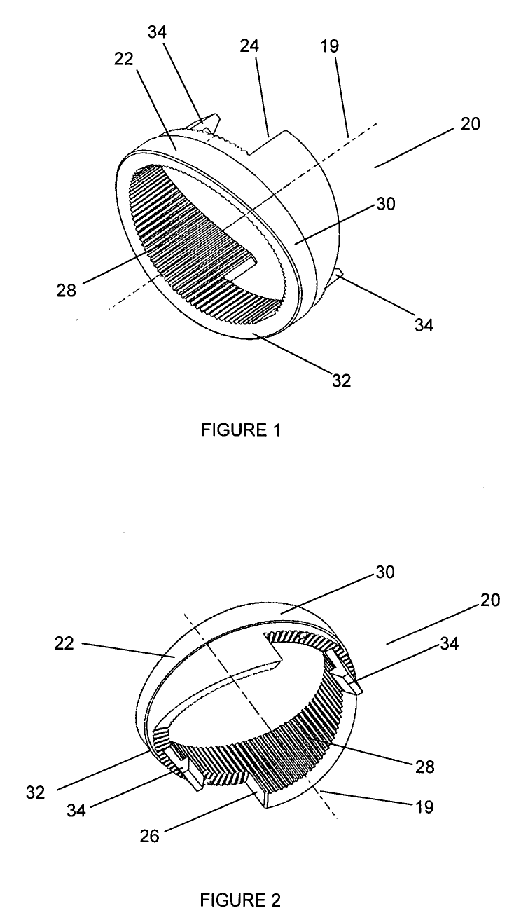

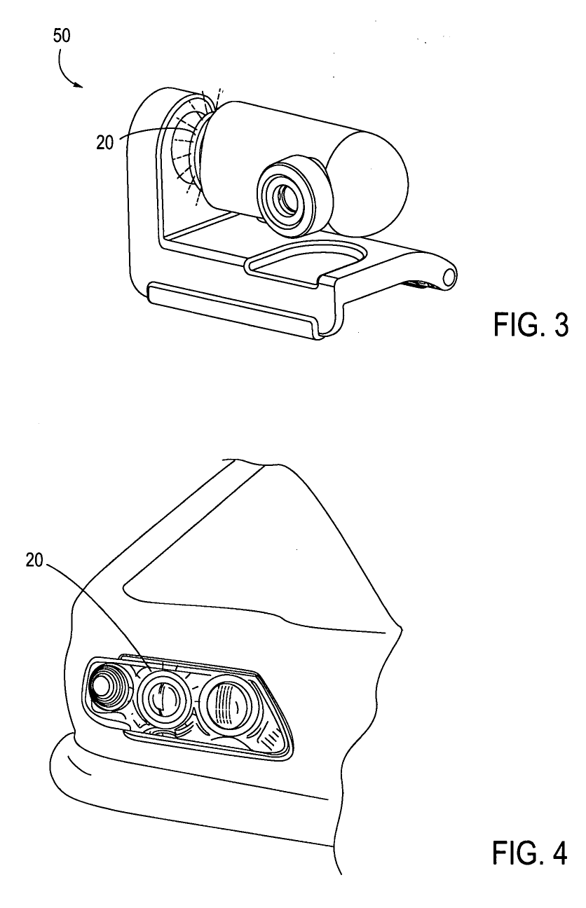

Referring to FIGS. 1 and 2, there is shown an apparatus 20 for providing an ambient glow. The apparatus 20 may include a substantially cylindrical structure 22, where an actual form of the apparatus 20 depends on objects which the apparatus 20 is to be mounted upon. A central axis 19 for the apparatus 20 is shown. It should be noted that a cross-sectional profile of the apparatus 20 is not constrained to a circle. The apparatus 20 may have an elliptical or even a polygonal cross-sectional profile. The apparatus 20 as shown in FIGS. 1 and 2 is used as part of a webcam 50 that is shown in FIG. 3.

The apparatus 20 may include at least one entry point 24 for light incorporated in the substantially cylindrical structure 22. Two entry points 24, 26 are denoted in the apparatus 20. The inner surface 28 of the substantially cylindrical structure 22 may be ridged in a uniform pattern. The ridges at the inner surface 28 of the substantially cylindrical structure 22 are uniform so as to enable reflection of the light entering at the entry points 24, 26 along the inner surface 28. In this regard, the apparatus 20 is able to provide the ambient glow due to the reflection of light along the ridged inner surface 28 of the substantially cylindrical structure 22. The entry point for light may include a holder for either at least one LED or at least one bulb, as a source for the light may be either LEDs or bulbs. It should be noted that an entry point for light need not denote a source of light. A single source of light may be used to generate light for transmission into multiple entry points for light. Light entering the entry point may be from any direction. This allows for greater flexibility in locating and positioning the source of light as there may be constraints due to a size/form factor of an object that the apparatus 20 may be coupled with.

The inner surface 28 of the substantially cylindrical structure 22 may be reflective in a manner like having a mirror-like finish. The better the reflective capability of the ridges of the inner surface 28, the brighter the ambient glow of the apparatus 20. The ambient glow may be in a colour of the source of light. Distribution of light in the apparatus 20 may be uniform such that the apparatus 20 glows in a single shade of colour without any discolouration/change in colour shade in any areas of the apparatus 20. The uniform distribution of light in the apparatus 20 may depend on dimensions of the apparatus 20, and/or intensity of the light entering the apparatus 20 via the entry points 24, 26. More entry points for light may be required if the apparatus 20 is physically large. It should be noted that more entry points for light need not mean more sources of light. Similarly, a single entry point of light may be adequate if the apparatus 20 is physically small.

It is possible for the ambient glow from the apparatus 20 to be in more than one colour. For example, if blue light is passed into entry point 24, and red light is passed into entry point 26, a top portion 30 of the apparatus 20 may have a blue ambient glow, while a bottom portion 32 of the apparatus 20 may have a red ambient glow. In addition, regions where the blue ambient glow and the red ambient glow overlap may give rise to a purple glow. This practice may be done for aesthetic reasons. The surfaces of the top portion 30 and the bottom portion 32 of the apparatus 20 may be textured for a uniform glowing effect.

The apparatus 20 may be made from a translucent solid material so that a shape of the apparatus 20 is maintained and light passes within the apparatus 20. The apparatus 20 may also include attachment clips 34 for mounting the apparatus 20 onto objects. In this instance, the clips 34 are used to mount the apparatus 20 onto the webcam 50 as per the assembly as shown in FIG. 3. Adhesives may also be used to mount the apparatus 20 instead of the clips 34. The webcam 50 denoted in FIG. 3 is the Live! Cam Optia from Creative Technology Ltd. The apparatus 20 is used to provide a blue glow for a portion of the webcam 50 for aesthetic reasons. The blue glow may also be an indication that the webcam 50 is operational.

Referring to FIG. 4, there is shown an alternative application for the apparatus 20. The apparatus 20 may be used to provide “angel-eye” illumination for vehicles. The “angel-eye” illumination for vehicles may be for aesthetic purposes as the apparatus 20 does not project sufficient light to illuminate areas in front of vehicles.

Whilst there has been described in the foregoing description preferred embodiments of the present invention, it will be understood by those skilled in the technology concerned that many variations or modifications in details of design or construction may be made without departing from the present invention.

1. An apparatus for providing an ambient glow, the apparatus including:
a substantially cylindrical structure;
at least one entry point for light incorporated in the substantially cylindrical structure; and
a ridged inner surface of the substantially cylindrical structure,
wherein the light entering at the at least one entry point is reflected by the ridged inner surface of the substantially cylindrical structure along the inner surface such that the apparatus provides the ambient glow.

2. The apparatus of claim 1, wherein the inner surface of the substantially cylindrical structure is reflective.

3. The apparatus of claim 1, wherein a source for the light is either LEDs or bulbs.

4. The apparatus of claim 3, wherein the ambient glow is in a colour of the source of light.

5. The apparatus of claim 1, further including attachment clips for mounting the apparatus onto objects.

6. The apparatus of claim 1, wherein distribution of light is uniform in the apparatus.

7. The apparatus of claim 1, wherein the at least one entry point for light includes a holder for either at least one LED or at least one bulb.

8. The apparatus of claim 1, wherein the ambient glow is in at least one colour.

9. The apparatus of claim 1, wherein the apparatus is made from a translucent solid material.

10. The apparatus of claim 1, wherein the inner surface of the substantially cylindrical structure is ridged uniformly.

11. The apparatus of claim 1, wherein light enters the at least one entry point from any direction.

12. The apparatus of claim 1, wherein the substantially cylindrical structure has a cross-sectional profile selected from the group consisting of: circle, elliptical and polygonal.
